(19) United States
(12) Patent Application Publication
(10) Pub. No.: US 2007/0294872 A1
(43) Pub. Date: Dec. 27, 2007

(54) TOOL FOR SERVICING VEHICLE BRAKING SYSTEMS

(76) Inventors: Richard E. Wallis, Rockford, MI (US); Robert J. O'Neil, Hesperia, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/765,514

(22) Filed: Jun. 20, 2007

Related U.S. Application Data
(60) Provisional application No. 60/815,082, filed on Jun. 20, 2006.

(51) Int. Cl. B25B 27/14; B25B 1/20; B23Q 1/25

(52) U.S. Cl. 29/281.4; 269/43; 269/69

(57) ABSTRACT

A toot for servicing pneumatic brake systems and the like includes a primary structural member, and a pair of mounting members or plates. The tool can be readily secured in a vise or the like, and a pneumatic valve to be replaced can be secured to a first one of the mounting plates. A replacement pneumatic valve is secured to the other of the two mounting plates, preferably in the same orientation as the pneumatic valve being replaced. The air lines can be readily disconnected from the ports of the pneumatic valve being replaced, and reattached to the new pneumatic valve in a one-by-one manner. The tool rigidly secures the pneumatic valves to facilitate disconnection and attachments of the air lines by a technician using a wrench or the like, and the placement of the two pneumatic valves in a side-by-side configuration in the same orientation permits the air lines to be readily reattached to the correct ports of the new pneumatic valve.

### CROSS-REFERENCE TO RELATED APPLICATIONS

This application claims the benefit of U.S. Provisional Patent Application No. 60/815,082, filed on Jun. 20, 2006, the entire contents of which are incorporated herein by reference.

### BACKGROUND OF THE INVENTION

Braking Systems for large vehicles such as tractor-trailers (“18-wheelers”), buses, and the like often include braking systems that are pneumatically actuated. Such braking systems often include an air valve such as a “treadle” valve having a large number of ports that receive air lines to direct air to the brake actuators at each wheel. A treadle valve for all 18-wheeler typically includes twelve to fourteen different valves, and a school bus or the like may include around six valves.

If the treadle valve requires replacement due to wear, malfunction or the like, the valve is typically removed from the vehicle with the individual air lines remaining connected to the parts of the valve. The air lines are then disconnected from the old valve, and attached to the ports of the new, replacement valve. The new valve and air lines are then installed in the vehicle. Due to the very large number of air lines that need to be disconnected from the old valve and reconnected to the new valve, the air lines may be inadvertently reattached to the wrong port of the new valve. This type of error is often not discovered until the valve is reinstalled in the vehicle. Removal and installation of air valves is typically very time-consuming, such that errors involving incorrect attachment of air lines to the valve will often result in wasting a substantial amount of time.

Accordingly, a way to alleviate the problems associated with servicing of air valves for vehicle brake systems would be beneficial.

### BRIEF DESCRIPTION OF THE DRAWINGS

FIG. 1 is a partially exploded isometric view of a tool according to one aspect of the present invention with an old air valve and a new air valve attached thereto for servicing;

FIG. 2 is an isometric view of a portion of the tool of FIG. 1;

FIG. 3 is a top plan view of the tool part of FIG. 2;

FIG 4 is a side elevational view of the tool part of FIG. 2;

FIG. 5 is a front elevational view of a mounting member or plate that can be mounted to the tool part of FIGS. 2-4 to support an air valve;

FIG. 6 is a cross-sectional view of the mounting member of FIG. 5 taken along the line VI-VI; FIG. 5;

FIG. 7 is an isometric view of the mounting member;

FIG. 8 is a front elevational plan view of a universal mounting plate that can be utilized with the tool part of FIGS. 2-4 to support a variety of air valves having different shapes/mounting configurations; and

FIG. 9 is a bottom view of the universal mounting plate of FIG. 8.

### DETAILED DESCRIPTION OF THE PREFERRED EMBODIMENT

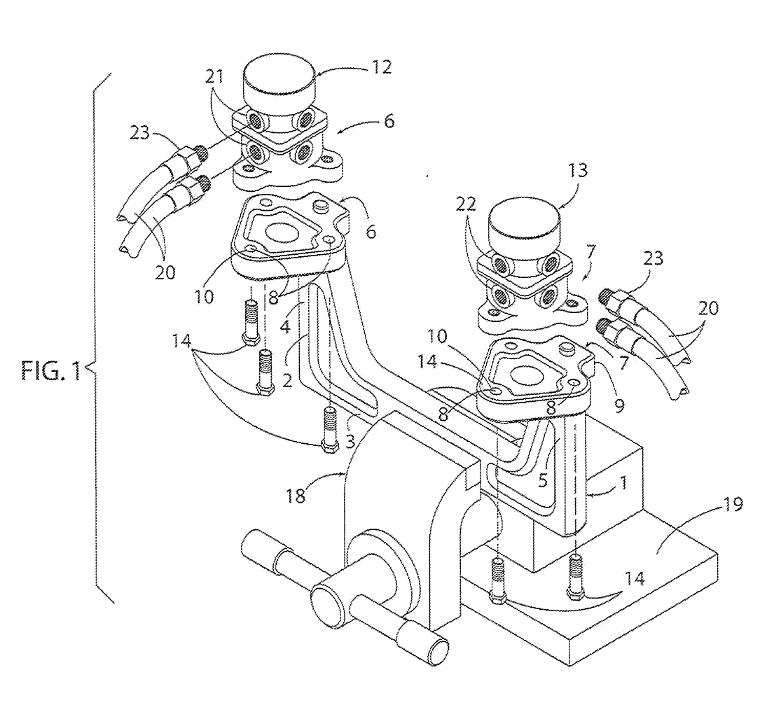

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to he understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

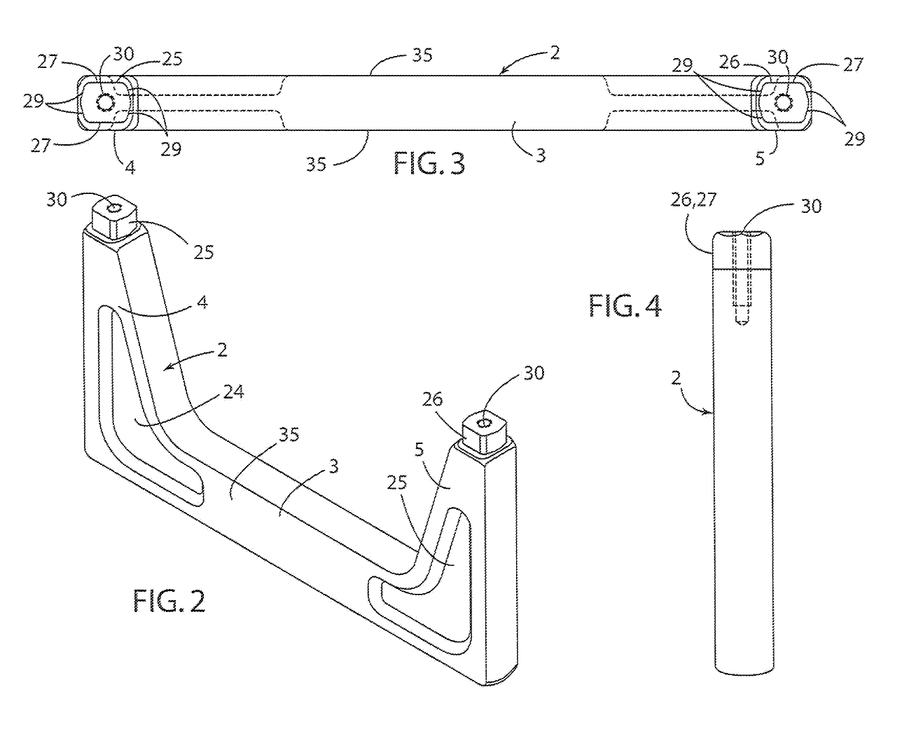

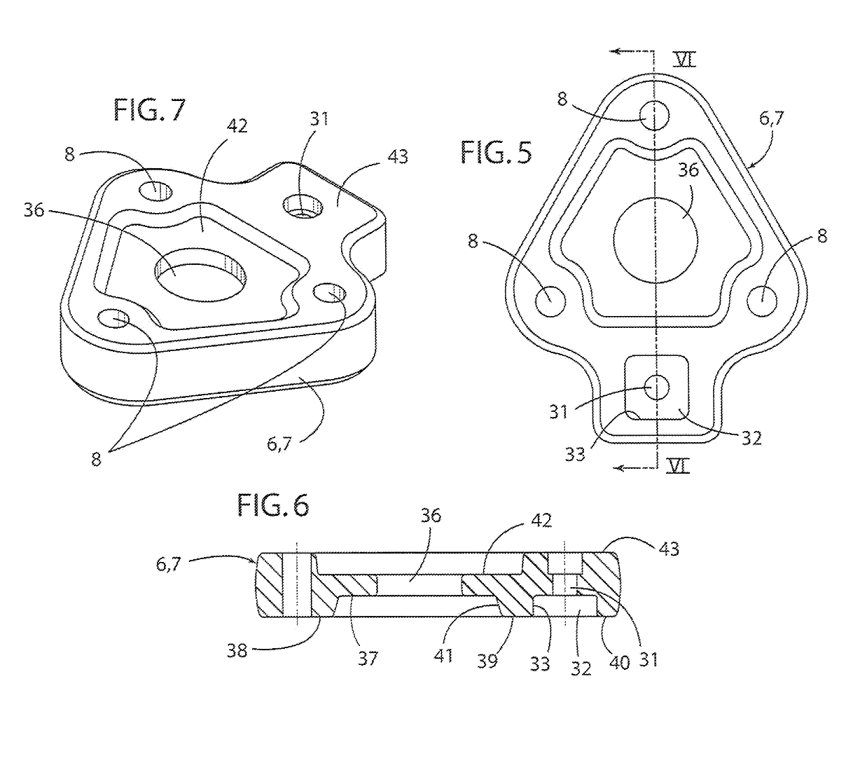

With reference to FIGS. 1 and 2, a tool 1 according to one aspect of the present invention includes a primary structural member 2 having a central portion 3, and end portions 4 and 5 that extend transversely from central portion 3. First and second, mounting plates or members 6 and 7 (see also FIGS. 5-7) are secured to end portions 4 and 5. The mounting members 6 and 7 each include a plurality of openings 8 forming hole patterns 9 that are substantially the same as hole pattern 10 of pneumatic (“air”) valves 12 and 13. In the illustrated example, the hole pattern 10 of each valve 10, 12 comprises three threaded openings forming a triangle pattern, with each opening receiving a conventional ⅜ inch course threaded fasteners stick as bolts 14. However, other valves may have different hole patterns/fastener configurations, and the hole pattern 10 may therefore be configured differently as required to accommodate a specific valve configuration. In the illustrated example, openings 8 comprise clearance holes through which conventional threaded fasteners (bolts) 14 pass, and hex nuts or the like 15 engage the bolts 14 to thereby rigidly secure the air valves 12 and 13 to the mounting plates or members 6 and 7. Openings 8 may have a diameter that is 1/32 or 1/16 of an inch greater than the outer diameter of the threads of bolts 14. In the illustrated example, the openings 8 are spaced apart a distance of about 2.50 inches and form a triangular pattern that matches the hole pattern of known treadle valves. However, it will be understood that openings 8 could be threaded, such that bolts 14 would secure the air valves 12 and 13 directly to the mounting members 6 and 7. A variety of other suitable fastening devices could also be utilized.

With reference to FIGS. 2-4, primary structural member 2 includes connectors 25 and 26 at the ends of end portions 4 and 5, respectively. The connectors 25 and 26 include opposed flat surfaces 27, and flat angled surfaces 29. The angled surfaces 29 are included to permit the primary structural member 2 to be removed from a mold during the casting process. The angled surface portions 29 are then machined to form opposed flat surfaces, such that the cross-sectional shape oft connectors 25 and 26 is substantially square. Connectors 25 and 26 also include threaded openings 30 that receive a threaded fastener that extends through clearance openings 31 in mounting members 6 and 7 (see also FIGS. 5-7). In a preferred embodiment, primary structural member 2 includes thin-wall portions 24 to reduce the weight of primary structural member 2. Side surfaces 35 of central portion 3 are substantially flat, and provide for securing the primary structural member 2 in a vise or the like. In a preferred embodiment, primary structural member 2 includes smoothly radiused corners, edges, and other such surfaces, and the structural member 2 may be cast from metal or other suitable material.

With further reference to FIGS. 5-7, the mounting members 6 and 7 are substantially identical, and include a cavity 32 with side walls 33. Side walls 33 define the rectangular cross-sectional shape of cavity 32. Plates 6 and 7 are secured to primary structural member 2 by inserting connectors 25 and 26 into cavity 32, and a threaded fastener such as a socket-head cap screw (not shown) or the like is inserted through clearance openings 31 and threaded into threaded opening 30. Mounting members 6 and 7 are thereby rigidly secured to the primary structural member 2 to permit application of the necessary torque for connection and disconnection of fittings 23 with ports 21 and 22.

A large central opening 36 extends through the mounting members 6 and 7 to reduce the amount of material required to cast or otherwise form the connectors 6 and 7. A first clearance pocket 37 further reduces the amount of material required, and is formed by a surface 41 that is offset from outer side surfaces 38, 39 and 40. A second pocket 42 is formed on tipper side 43 of mounting members 6 and 7 to provide clearance for portions of the air valves and reduce the amount of material required. The mounting plates or members 6 may be made of cast metal or other suitable material.

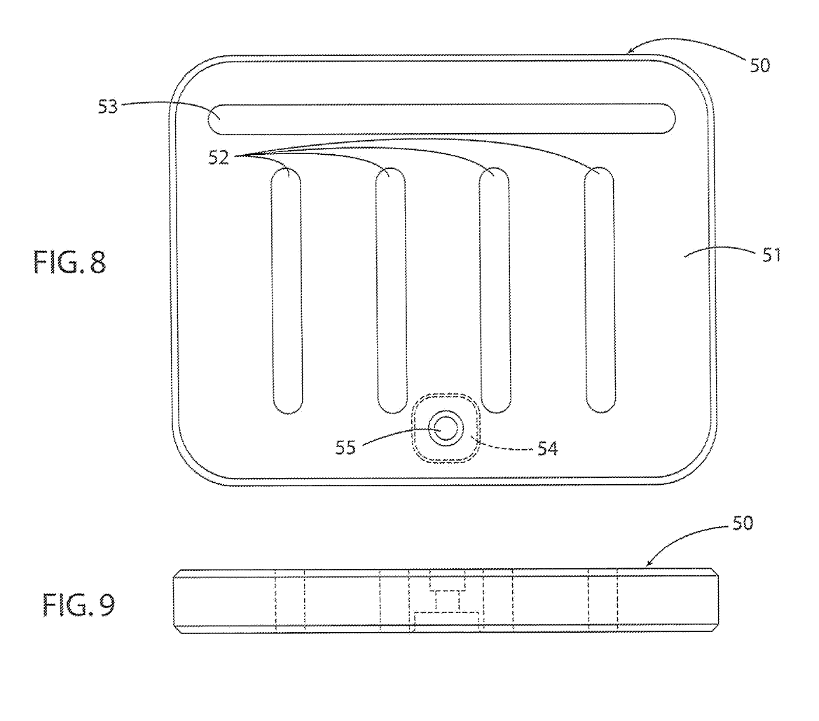

With further reference to FIGS. 8 and 9, a “universal” mounting plate 50 has a plate-like main portion 51, and a plurality of first slots 52 that are parallel to one another and extend in a first direction. A slot 53 extends perpendicular to slots 52. In the illustrated example, slots 52 and 53 are about 0.344 inches wide to freely receive a conventional ⅜ inch threaded fastener. The overall dimensions of mounting plate 50 are 5.00 inches by 6.50 inches in plan view (FIG. 8) with a thickness of 0.75 inches (FIG. 9), and slots 52 are spaced apart about 1.250 inches. Mounting plate 50 includes a cavity 54 that has substantially the same size and shape as cavity 32 of minting members 6 and 7. Cavity 54 receives connectors 25 and 26 of primary structural member 2, and a counter-bored opening 55 receives a threaded fastener such as a socket-head cap screw or the like that is threadably received in threaded openings 30 of primary structural member 2. In this way, a pair of universal plates 50 can be rigidly secured to primary structural member 2.

In use, threaded fasteners can be inserted into selected ones of the slots 52, and slot 53 of universal mounting plate 50, and also through the clearance openings 8 of pneumatic valves 12 and 13 to thereby rigidly connect the pneumatic valves to the universal plates 50. The slots 52 and 53 permit air valves having a wide range of bolt patterns to be rigidly connected to the universal plate 50.

With reference back to FIG. 1, in use, tool 1 may be clamped in a vise 8 on a bench 19 or the like, with an old pneumatic valve 12 secured to mounting member 6, and a new replacement pneumatic valve 13 rigidly secured to mounting plate or member 7. Pneumatic lines 20 are detached from ports 21 in old air valve 12, and then attached to corresponding ports 22 in new air valve 13. It will be understood that fittings 23 of air lines 20 are of a conventional design, and provide an air-tight seal when attached to ports 21 ad 22. Because the old valve 12 and the new valve 13 are positioned side-by-side, in substantially the same orientation, a technician can readily ensure that each air line 20 is properly connected to the correct port 22 in new air valve 13. Preferably, the air lines 20 are disconnected from old air valve 12 and reconnected to new air valve 13 in a one-by-one manner to avoid any potential confusion.

In the foregoing description, it will be readily appreciated by those skilled in the art that modifications may be made to the invention without departing from the concepts disclosed herein.

The invention claimed is:

1. A fixture for retaining valves of a vehicle brake system, the fixture comprising:
a base portion having an elongated central portion with upper and lower surfaces and opposite side faces configured to permit the base portion to be clamped in a vice with jaws of a vice in contact with the opposite side faces, the base portion including opposite end portions that extend upwardly above the upper surface of the central position, each opposite end portion having an upper end that includes a valve-retaining structure, the valve-retaining structures including upwardly facing support surfaces that, in use, support a valve in substantially the same orientation, the valve-retaining structures further comprising a plurality of openings adapted to receive a plurality of threaded fasteners for rotation about generally upright axis to thereby mount the valves to the fixture.

2. The fixture of claim 1, wherein:
the opposite end portions comprise an upwardly-protruding boss having non-circular outer surfaces;
the valve-retaining structures comprise plate members each plate member having an opening that closely receives the boss and prevents rotation of the plate member relative to the base portion.

3. The fixture of claim 2, wherein:
threaded openings in each boss.

4. The fixture of claim 2, wherein:
each boss includes planar opposite side surfaces; and
each opening in each plate includes flat side surfaces that fit closely adjacent the opposite side surfaces of the bosses.

5. The fixture of claim 2, wherein:
the openings of the valve-retaining structures comprise three openings forming an equilateral triangle pattern wherein the openings are spaced apart about 2.5 inches, and have a diameter of at least about 0.375 inches.

6. The fixture of claim 2, wherein:
the openings of the valve-retaining structures comprise at least two elongated slots.

7. The fixture of claim 2, wherein:
the openings of the valve-retaining structures comprise a first group of slots that are generally parallel to one another, and a second slot that is transverse relative to the slots of the first group.

8. The fixture of claim 7, wherein:
the slots of the first group are spaced apart about 1.25 inches from adjacent slots of the first group.

9. The fixture of claim 7, wherein:
the slots are straight, and have a width that is great enough to freely receive a conventional ⅜ inch threaded fastener.
